(19) United States
(12) Patent Application Publication
(10) Pub. No.: US 2004/0118827 A1
(43) Pub. Date: Jun. 24, 2004

(54) Weld bracket

(76) Inventors: Sivakumar Ramasamy, Utica, MI (US); Matthew M. Geno, Macomb, MI (US)

Correspondence Address: HARNESS, DICKEY & PIERCE, P.L.C., P.O. BOX 828, BLOOMFIELD HILLS, MI, 48303, US

(21) Appl. No.: 10/680,568

(22) Filed: Oct. 7, 2003

Related U.S. Application Data
(60) Provisional application No. 60/418,463, filed on Oct. 15, 2002.

(51) Int. Cl. B23K 9/00

(52) U.S. Cl. 219/137 R

(57) ABSTRACT

An L-shaped weld-fast bracket is disclosed for welding to thin sheet metal. The bracket has a surface which is configured to mate with the thin sheet metal having a depth being a multiple of the thickness of the sheet metal.

### CROSS-REFERENCE TO RELATED APPLICATIONS

This application claims the benefit of U.S. Provisional Application No. 60/418,463 filed on Oct. 15, 2002. The disclosure of the above application is incorporated herein by reference.

### FIELD OF THE INVENTION

The present invention relates to a weldable bracket for sheet metal and, more particularly, to a thin L-shaped bracket for welding to very thin sheet metal.

### BACKGROUND OF THE INVENTION

Increased fuel economy requirements in the transportation industries are requiring lighter and lighter vehicles. As such, vehicle manufacturers are required to find weight reductions throughout the vehicle. One method of accomplishing such weight reduction is to reduce the thickness of sheet metals used to form the outer skin and interior portions of a vehicle's body.

To couple sheet metal panels to other portions of the vehicle frame, thin flanges are typically welded to the sheet metal panel. Additionally, flanges are welded to sheet metal to function as electrical grounds or mounting locations for vehicle components such as wire harnesses. These weld flanges often are coupled to the sheet metal using weld guns to weld the weld flange perpendicular to the sheet metal. In this regard, the weld flange is typically planar and has a contact surface equal to the width and thickness of the flange.

Often in situations where the sheet metal is thinner than the flange, the base sheet metal is so locally heated by the flange that marking occurs within the base sheet opposite the weld flange. Additionally, when subject to vary high welding currents, a through hole may be produced in the base sheet metal. This is especially true in sheet metal constructions when the sheet metal has a thickness of less than or equal to 1.2 mm. In situations where the electrical current to produce a weld is reduced so as not to cause destruction or marking of the sheet metal, the weld is not of a suitable strength to mount the sheet metal to a vehicle structure.

### SUMMARY OF THE INVENTION

Accordingly, it is an object of the present invention to provide a weld fast bracket which overcomes the deficiencies of the prior art. Specifically, an L-shaped weld-fast bracket is disclosed for welding to thin sheet metal. The bracket has a surface which is configured to mate with the thin sheet metal having a depth of from X to 5 times the thickness of the sheet metal base material. Where X equals the thickness of the bracket plus the thickness of the base material.

In accordance with another embodiment of the invention, a weld bracket to sheet metal construction is provided. The sheet metal has a first thickness. The depth of a flange is the function of the first thickness. A weldment portion is provided between the flange and the base metal.

In another embodiment of the invention, a method of coupling a bracket to a sheet metal base having a thickness less than 1.2 mm is provided. The method includes forming a flange on the bracket. The flange is then positioned so as to contact the sheet metal. Current is applied to the bracket while the bracket is being moved away from the sheet metal so as to form a welding arc. The bracket is then forced into a pool of weldment material.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of the bracket and base material according to the teachings of the present invention;

FIGS. 2a and 2b represent an alternate embodiment of the invention; and

FIGS. 3a and 3b represent the brackets shown in FIGS. 1 and 2 coupled to a sheet metal structure.

### DETAILED DESCRIPTION OF THE PREFERRED EMBODIMENTS

The following description of the preferred embodiment(s) is merely exemplary in nature and is in no way intended to limit the invention, its application, or uses.

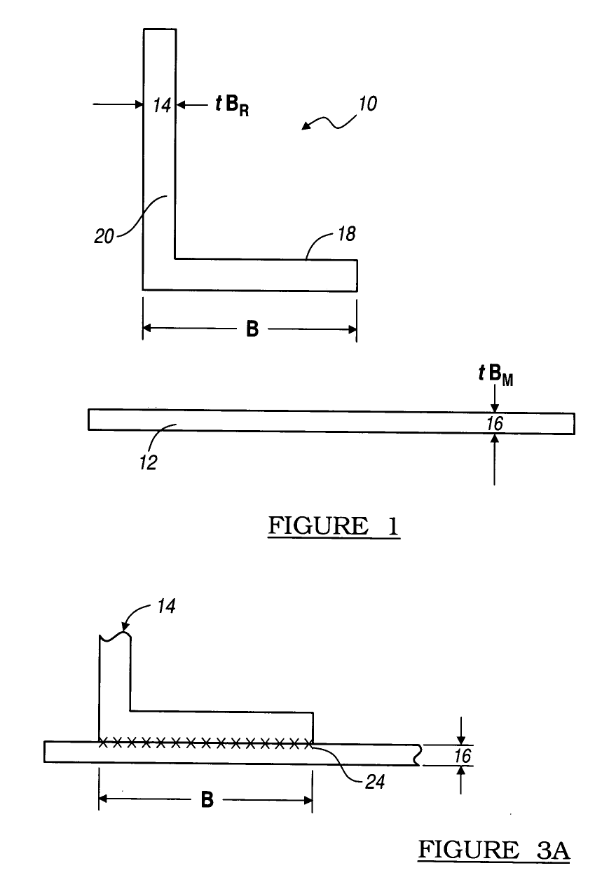

FIG. 1 depicts an angular weld bracket 10 which is welded to a base sheet metal component 12. The weld bracket 10 has a thickness 14 of T_{br} while the sheet metal component 12 has a thickness 16 of T_{bm}. The bracket has a flange 18 which is general perpendicular to a bracket body 20.

The flange 18 has a depth B and a width C. In circumstances where the thickness 16 of the sheet metal component 12 is greater than the thickness of the bracket 14 or the thickness of the sheet metal component is greater than 1.2 mm, then flange 18 is not needed and the flat bracket body 20 can be welded directly to the base material 16. The bracket width C is from 1.0 to about 30 mm depending upon the strength needed.

Under circumstances when the thickness of the bracket material 14 is greater than the thickness 16 of the sheet metal component 12 or the thickness of the sheet metal component 12 is less than or equal to 1.2 mm, then the depth of the base flange B is equal to a multiplication factor (X) times the thickness of the base material. In this regard, the depth of the flange is a function described below:

t_{BM}=Sheet Metal Base Material Thickness

t_{BR}=Bracket Material Thickness

t_{BM}<t_{BR} or t_{BM}<1.2 mm

B=xt_{BM}

y≦x≦5

Y=t_{BM}+t_{BR}

The lower limit for the multiplication factor (X) is equal to the thickness 16 of the bracket 14 plus the thickness of the sheet metal 12 base material, while the upper limit for multiplication factor is 5. It has been found that the multiplication of factor of 2 to 3 is preferred. These ratios are best applied to brackets 10 having a thickness 14 of greater than or equal to 0.5 mm up to and including 5 mm. Further, the ratios are most applicable to base materials having a thickness 16 of greater than or equal to 0.5 mm up to and including 1.20 mm.

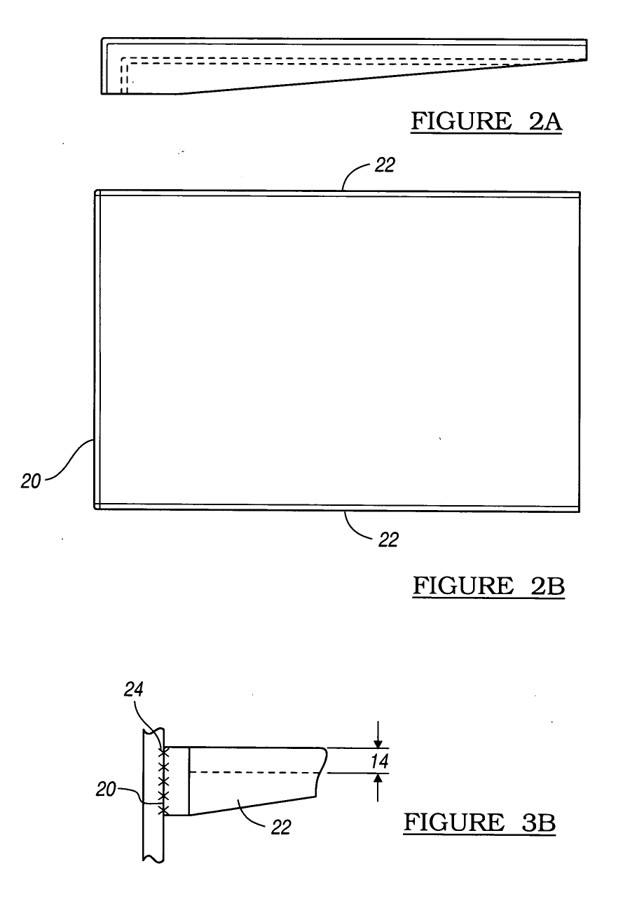

FIGS. 2a and 2b represent an alternate embodiment of the present invention. As shown, the bracket further has a pair of triangular side support members 22. The bracket has a flange 20 which conforms to the size requirements as described for the embodiment of FIG. 1. In using the weldment area of the flange, heating of the base sheet metal is distributed over a greater area as opposed to the prior art. Damage to the surface of the sheet metal is reduced and the strength of the weld to surface interface is improved.

FIG. 3a represents a welded construct according to teachings of the first embodiment of the invention. Shown is a weld bracket 10 coupled to the base 12 by a weldment portion 24. As seen, the bracket 10 has a thickness 14 greater than the thickness of the sheet metal 16. It is envisioned that the bracket 10 will be coupled to the sheet metal by the wetting of a majority of the flange 18 with molten metal.

Similarly, FIG. 3b represents the weld bracket construct coupled to the sheet metal by the weldment portion 24. The brackets 20 are coupled to the sheet metal using a drawn arc method. In this regard, a flange 20 is positioned against a surface of the sheet metal 12. Welding current is applied to the bracket 10 or 20 and through the sheet metal. The bracket 10 or 20 is lifted slightly off the surface of the sheet metal 12 forming a welding arc therebetween.

Molten metal is formed between the sheet metal 12 and the flange 18. The bracket 10 or 20 is then plunged into the liquid metal and the welding current is removed, thereby coupling the bracket 10 or 20 to the surface of the sheet metal 12.

The description of the invention is merely exemplary in nature and, thus, variations that do not depart from the gist of the invention are intended to be within the scope of the invention. Such variations are not to be regarded as a departure from the spirit and scope of the invention. For example, it is envisioned that the base sheet metal can be a laminate construction formed of very thin layers of aluminum or steel separated at least partially by a non-conductive polymer layer.

What is claimed is:

1. A weld bracket configured to be welded to a sheet metal surface, the sheet metal surface having a first thickness of less than 1.2 mm, comprising:
a body portion having a second thickness; and
a flange portion coupled perpendicular to the body portion, said flange portion having a depth being a multiple of the first thickness.

2. The weld bracket according to claim 1 wherein the multiple is equal to or greater than the thickness of the base material plus the thickness of the bracket material and less than or equal to 5.

3. The weld bracket according to claim 2 further comprising a pair of side triangular support members.

4. The weld bracket according to claim 1 wherein the first thickness is less than the second thickness.

5. The weld bracket according to claim 1 wherein the bracket has a width between about 1 and 30 mm.

6. The weld bracket according to claim 1 wherein the depth is greater than the first thickness plus the second thickness times the first thickness.

7. The weld bracket according to claim 1 wherein the depth is less than 5 times the first thickness.

8. A weld bracket to sheet metal construction comprising:
a sheet metal base having a first thickness;
a weld bracket having a body portion having a second thickness and a flange portion, said flange portion having a depth which is a function of the first thickness; and
a weldment portion disposed between the flange and the sheet metal base, wherein said second thickness is greater than the first thickness.

9. The construction according to claim 8 wherein the first thickness is less than 1.2 mm.

10. The construction according to claim 8 wherein the bracket has a width between about 1 mm and about 30 mm.

11. The construction according to claim 8 wherein the depth is greater than the first thickness plus the second thickness times the first thickness.

12. The construction according to claim 8 wherein the depth is less than or equal to 5 times the first thickness.

13. The construction according to claim 8 wherein the flange portion is coupled perpendicular to the body and wherein said flange portion has a depth being equal to or greater than the thickness of the base material plus the thickness of the bracket material and less than or equal to 5.

14. A method for coupling the weld bracket to a sheet metal component having a first thickness less than 1.2 mm comprising:
providing a bracket having a second thickness which is greater than the first thickness;
forming a flange portion on said weld bracket;
coupling said flange to said metal component;
applying electric current to the flange;
lifting the weld bracket so as to cause an arc between the flange and the base material, wherein liquid weldment material is produced;
forcing the weld bracket into the liquid weldment area; and
removing the electric current.

15. The method according to claim 14 wherein forming a flange portion is forming a flange having a depth being a multiple of the first thickness.

16. The method according to claim 14 wherein forming a flange is forming a flange having a depth of greater than the thickness of the base material plus the thickness of the bracket material times the thickness of the bracket material and less than or equal to 5 times the thickness of the base material.

17. The method according to claim 14 wherein the bracket has a width between 1 and 30 mm.

18. The method according to claim 14 wherein the depth is greater than the first thickness plus the second thickness times the first thickness.

19. A weld bracket configured to be welded to a metal base having a first thickness of less than or equal to 1.2 mm, comprising:
a bracket formed of sheet metal having a second thickness, said bracket having a flange having a depth which is a function of the first thickness.

20. The weld bracket according to claim 19 wherein the depth is a multiple times the thickness of the sheet metal, said multiple being between the first thickness plus the second thickness and 5.

21. The weld bracket according to claim 19 wherein the multiple is between about 2 and about 3.

22. The weld bracket according to claim 19 wherein the second thickness is between 0.5 mm and 5 mm.

23. The weld bracket according to claim 19 wherein the first thickness is between 0.5 mm and about 1.2 mm.
